(19) United States
(12) Patent Application Publication
(10) Pub. No.: US 2006/0069508 A1
(43) Pub. Date: Mar. 30, 2006

(54) Collision determining apparatus for a vehicle

(76) Inventors: Fang Yuan, Kawachi-gun (JP); Tatsuji Oosaki, Utsunomiya-shi (JP)

Correspondence Address: FISH & RICHARDSON PC, P.O. BOX 1022, MINNEAPOLIS, MN, 55440-1022, US

(21) Appl. No.: 11/228,553

(22) Filed: Sep. 16, 2005

(30) Foreign Application Priority Data
Sep. 24, 2004 (JP) P2004-277697

(51) Int. Cl. G08G 1/16

(52) U.S. Cl. 701/301

(57) ABSTRACT

A collision determining apparatus for a vehicle includes: a first acceleration measuring device; a second acceleration measuring device; a first change in movement speed calculating device which calculates a first change in movement speed; an interval integral value calculating device; a second change in movement speed calculating device; a first collision determining device; a continuation determining device; a second collision determining device; a collision determination continuing device which sets a collision continuation determining value to an ON state or OFF state based on the first change in movement speed and the interval integral value; and a control signal generating device which generates a control signal instructing that an occupant protection apparatus be operated based on the collision continuation determining value and the second change in movement speed.

### BACKGROUND OF THE INVENTION

1. Field of the Invention

The present invention relates to a collision determining apparatus for a vehicle that determines a vehicle collision, and causes an occupant protection apparatus such as, for example, an airbag apparatus or a seatbelt pretensioner to be operated.

Priority is claimed on Japanese Patent Application No. 2004-277697, filed Sep. 24, 2004, the contents of which are incorporated herein by reference.

2. Description of Related Art

Conventionally, collision determining apparatuses for vehicles are known that are provided with a plurality of acceleration sensors that are placed in different locations and, for example, measure the acceleration (or the deceleration) that is applied to a vehicle. These collision determining apparatuses cause an occupant protection apparatus such as an airbag apparatus or a seatbelt pretensioner to be operated in accordance with the results of a comparison between respective integral values that are obtained by performing primary integration for time on acceleration signals that are output from each acceleration sensor (for example, refer to Japanese Unexamined Patent Application, First Publication No. 2001-277994).

In a collision determining apparatus for a vehicle based on the above conventional technology, in accordance, for example, with the state of a collision that is occurred and with the placement positions of each of the acceleration sensors, there are cases when a relatively sizeable discrepancy arises in the timings at which integral values of accelerations signals from each acceleration sensor are at their maximum. In such cases, if settings are made such that the operation of the occupant protection apparatuses is controlled, for example, in accordance with whether or not the integral values of the acceleration signals from the plurality of acceleration sensors exceeds predetermined respective determination threshold values, then a discrepancy arises in the timings at which it is determined that the integral values of the accelerations signals exceed the predetermined determination threshold values in each of the acceleration sensors. Consequently, the problem arises that it is difficult to appropriately control the operation of the occupant protection apparatuses.

To deal with this problem, a method is known in which, for example, when it is determined that an integral value of acceleration signals from an appropriate acceleration sensor exceeds a predetermined determination threshold value, by maintaining this determination result as valid for a predetermined length of time, the discrepancy in the timings of the determinations between each of the plurality of acceleration sensors is eliminated. However, the problem arises that it is not possible to accurately determine whether or not a collision is occurred simply by maintaining a determination result for a predetermined length of time.

Moreover, in a method in which the determination threshold values for integral values of the acceleration signals are set to relatively small values so that the duration of the continuous detection of the collision state is lengthened, the problem arises that the determination of a collision occurrence is still performed superfluously even for collisions in which the operation of an occupant protection apparatus is unnecessary.

### SUMMARY OF THE INVENTION

The present invention was conceived in view of the above described circumstances and it is an object thereof to provide a collision determining apparatus for a vehicle that is capable of performing an accurate collision determination in a short length of time based on acceleration signals that are output from a plurality of acceleration sensors.

The collision determining apparatus for a vehicle of the present invention includes: a first acceleration measuring device which measures an acceleration acting on an outer peripheral portion of the vehicle; a second acceleration measuring device which measures an acceleration acting on a position further to an inner portion side of the vehicle than the first acceleration measuring device; a first change in movement speed calculating device which calculates a first change in movement speed based on the acceleration which is measured by the first acceleration measuring device; an interval integral value calculating device which calculates an interval integral value in a relatively long time interval for the acceleration which is measured by the first acceleration measuring device; a second change in movement speed calculating device which calculates a second change in movement speed based on the acceleration which is measured by the second acceleration measuring device; a first collision determining device which determines whether or not the first change in movement speed exceeds a predetermined first collision determining threshold value; a continuation determining device which determines whether or not the interval integral value exceeds a predetermined continuation determining threshold value; a second collision determining device which determines whether or not the second change in movement speed exceeds a predetermined second collision determining threshold value; a collision determination continuing device which sets a collision continuation determining value which indicates that a collision is in a state of continuation to an ON state when it is determined by the first collision determining device that the first change in movement speed exceeds the first collision determining threshold value and it is also determined by the continuation determining device that the interval integral value exceeds the continuation determining threshold value, and which sets the collision continuation determining value to an OFF state when it is determined by the continuation determining device that the interval integral value does not exceed the continuation determining threshold value; and a control signal generating device which generates a control signal which instructs that an occupant protection apparatus be operated when the collision continuation determining value is in an ON state and it is determined by the second collision determining device that the second change in movement speed exceeds the second collision determining threshold value.

According to the collision determining apparatus for a vehicle of the present invention, when, as a result of it first being determined that the first change in movement speed exceeds a first collision determining threshold value and of it also being determined that the interval integral value exceeds a continuation determining threshold value, the occurrence of a collision is detected based on acceleration which is measured by the first acceleration measuring device, then a collision continuation determining value which indicates that a collision is in a state of continuation is set to an ON state. This ON state of the collision continuation determining value continues for a period until the interval integral value becomes less than the continuation determining threshold value.

In addition, when it is determined that the second change in movement speed exceeds the second collision determining threshold value while the collision continuation determining value is still in an ON state, it is determined that a collision event requiring the operation of an occupant protection apparatus which is detected based on acceleration from the first acceleration measuring device is detected based on acceleration from the second acceleration measuring device, and a control signal which instructs that the occupant protection apparatus be operated is generated.

As a result, even when a relatively large discrepancy arises between the timings at which integral values of accelerations from each of the acceleration sensors are at their maximum as a result, for example, of the placements of each of the acceleration sensors and also because of the state of the collision which is occurred and the like, it is possible to accurately determine the existence or otherwise of a collision occurrence and to appropriately operate the occupant protection apparatus.

The collision determining apparatus for a vehicle of the present invention includes: a first acceleration measuring device that measures an acceleration acting on an outer peripheral portion of the vehicle; a second acceleration measuring device which measures an acceleration acting on a position further to an inner portion side of the vehicle than the first acceleration measuring device; a first change in movement speed calculating device which calculates a first change in movement speed based on the acceleration which is measured by the first acceleration measuring device; an interval integral value calculating device which calculates an interval integral value in a predetermined time interval for the acceleration which is measured by the first acceleration measuring device; a second change in movement speed calculating device which calculates a second change in movement speed based on the acceleration which is measured by the second acceleration measuring device; a first collision determining device which determines whether or not the first change in movement speed exceeds a predetermined first collision determining threshold value; a continuation determining device which determines whether or not the interval integral value exceeds a predetermined high side continuation determining threshold value or a predetermined low side continuation determining threshold value; a second collision determining device which determines whether or not the second change in movement speed exceeds a predetermined second collision determining threshold value; a collision determination continuing device which sets a collision continuation determining value which indicates that a collision is in a state of continuation to an ON state when it is determined by the first collision determining device that the first change in movement speed exceeds the first collision determining threshold value and it is also determined by the continuation determining device that the interval integral value exceeds the predetermined high side continuation determining threshold value, and which sets the collision continuation determining value to an OFF state when it is determined by the continuation determining device that the interval integral value is less than the predetermined low side continuation determining threshold value; and a control signal generating device which generates a control signal which instructs that an occupant protection apparatus be operated when the collision continuation determining value is in an ON state and it is determined by the second collision determining device that the second change in movement speed exceeds the second collision determining threshold value.

According to the collision determining apparatus for a vehicle of the present invention, when, as a result of it first being determined that the first change in movement speed exceeds the first collision determining threshold value and of it also being determined that the interval integral value exceeds the continuation determining threshold value, the occurrence of a collision requiring the operation of an occupant protection apparatus is detected based on the acceleration which is measured by the first acceleration measuring device, then a collision continuation determining value which indicates that a collision is in a state of continuation is set to an ON state. This ON state of the collision continuation determining value continues for a period until the interval integral value becomes less than the low side continuation determining threshold value, namely, for the period which is required for the collision energy to be reduced to a level where it does not cause any injury to an occupant.

In addition, when it is determined that the second change in movement speed exceeds the second collision determining threshold value while the collision continuation determining value is still in an ON state, it is determined that a collision event requiring the operation of an occupant protection apparatus which is detected based on the acceleration from the first acceleration measuring device is also detected based on the acceleration from the second acceleration measuring device, and a control signal which instructs that the occupant protection apparatus be operated is generated.

As a result, even when a relatively large discrepancy arises between the timings at which integral values of accelerations from each of the acceleration sensors are at their maximum as a result, for example, of the placement positions of each of the acceleration sensors and also because of the state of the collision which is occurred and the like, it is possible to accurately determine the existence or otherwise of a collision occurrence. Furthermore, it is possible to achieve an improvement in reliability when determining a continued collision state and to appropriately operate the occupant protection apparatus.

### BRIEF DESCRIPTION OF THE DRAWINGS

FIG. 1 is a view showing a first embodiment of the collision determining apparatus for a vehicle of the present invention, and is a schematic view of a vehicle which is equipped with a collision determining apparatus for a vehicle.

FIG. 2 is a block diagram of the collision determining apparatus for a vehicle.

FIG. 3 is a flow chart showing an operation of the collision determining apparatus for a vehicle.

FIG. 4 is a view showing an example of temporal changes in a change in movement speed of an occupant ΔV_{hold}.

FIG. 5 is a view showing an example of temporal changes in a change in movement speed of an occupant ΔV_{SIS}.

FIG. 6 is a view showing an example of temporal changes in a change in movement speed of an occupant ΔV_{ECU}.

FIG. 7 is a view showing a variant example of the first embodiment of the collision determining apparatus for a vehicle of the present invention, and is a flowchart showing an operation of the collision determining apparatus for a vehicle.

FIG. 8 is a view showing an example of temporal changes in a change in movement speed of an occupant ΔV_{hold}.

### DETAILED DESCRIPTION OF THE INVENTION

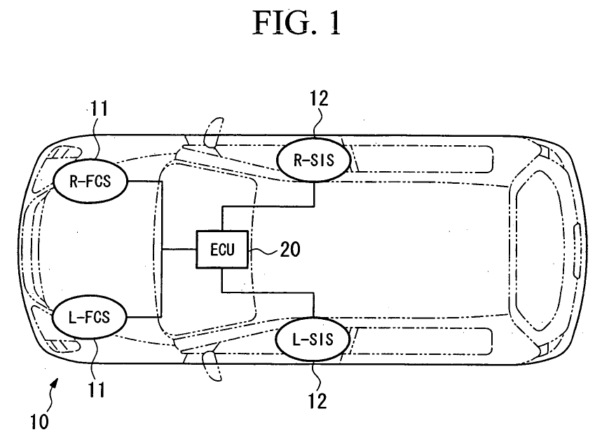

An embodiment of the collision determining apparatus for a vehicle of the present invention will now be described with reference made to FIGS. 1 through 8.

As is shown in FIG. 1, a collision determining apparatus for a vehicle 10 of the present embodiment is provided with an electronic control unit (ECU) 20 that is located in the center of the vehicle and a plurality of satellite sensors. The satellite sensors are formed by a plurality of acceleration sensors, for example, two front crash sensors (i.e., L-FCS and R-FCS) 11 that are located at a right front portion and a left front portion of the vehicle, and two side impact sensors (first acceleration measuring device (i.e., L-SIS and R-SIS)) 12 that are located at a right side portion and a left side portion of the vehicle. Acceleration signals that are output from the respective satellite sensors are input into the electronic control unit 20.

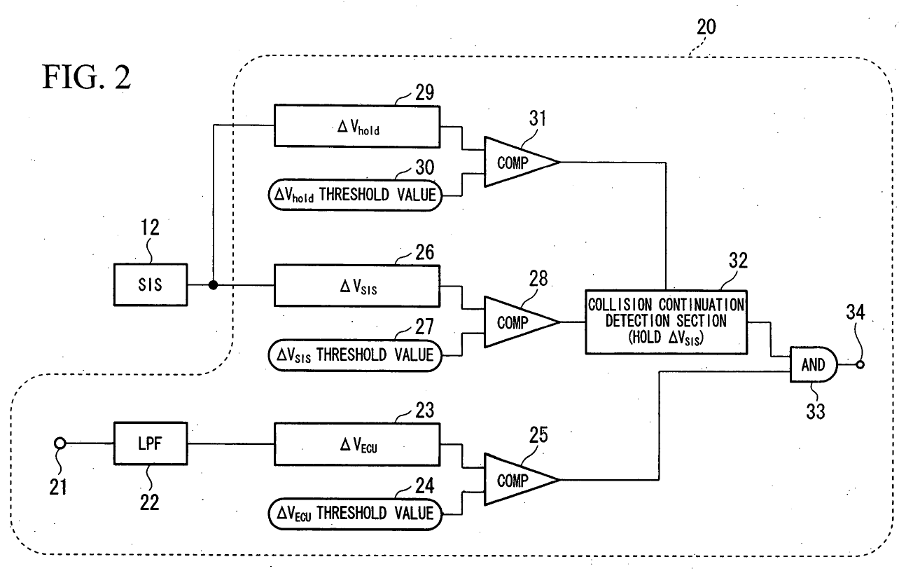

As is shown in FIG. 2, the electronic control unit 20 is provided with an acceleration sensor (second acceleration measuring device) 21, a filter processing section 22, a ΔV_{ECU} calculation section (second change in movement speed calculating device) 23, a ΔV_{ECU} threshold value setting section 24, a ΔV_{ECU} comparison section (second collision determining device) 25, a ΔV_{SIS} calculation section (first change in movement speed calculating device) 26, a ΔV_{SIS} threshold value setting section 27, a ΔV_{SIS} comparison section (first collision determining device) 28, a ΔV_{hold} calculation section (interval integral value calculating device) 29, a ΔV_{hold} threshold value setting section 30, a ΔV_{hold} comparison section (continuation determining device) 31, a collision continuation detecting section (collision determination continuing device) 32, an AND circuit 33, and a startup signal generating section (control signal generating device) 34.

The acceleration sensor 21 outputs acceleration signals G at a voltage level that matches the size of acceleration (or deceleration) acting, for example, in a longitudinal direction or transverse direction of a vehicle.

The filter processing section 22 is equipped with a low pass filter (LPF) that removes high frequency components, which are noise components, from the accelerations signals G that are output from the acceleration sensor 21.

The ΔV_{ECU} calculation section 23 performs a primary integration for time on the acceleration signals G that are output from the filter processing section 22, and, as is shown below in Formula (1), for example, calculates a change in movement speed of an occupant ΔV_{ECU} in a time interval having a predetermined time width n relative to the current time tp (i.e., tp−n≦t≦tp), and outputs the result to the ΔV_{ECU} comparison section 25.

The ΔV_{ECU} comparison section 25 determines whether or not the change in movement speed of an occupant ΔV_{ECU} that is input from the ΔV_{ECU} calculation section 23 is greater than a predetermined ΔV_{ECU} threshold value that is input from the ΔV_{ECU} threshold value setting section 24. When the result of this determination is “YES”, then a determination value having a true value of “1” is output to the AND circuit 33. When, however, the result of the determination is “NO”, then a determination value having a pseudo value of “0” is output to the AND circuit 33.

$$Δ {V}_{ECU} = {\int }_{tp - n}^{tp} {G}_{ECU} ( t ) ⅆ t \qquad ( 1 )$$

The ΔV_{SIS} calculation section 26 performs a primary integration for time on the acceleration signals G_{SIS} that are output from a side impact sensor (i.e., L-SIS or R-SIS) 12, and, as is shown below in Formula (2), for example, calculates a change in movement speed of an occupant ΔV_{SIS} in a time interval having a predetermined time width n relative to the current time tp (i.e., tp−n≦t≦tp), and outputs the result to the ΔV_{SIS} comparison section 28.

The ΔV_{SIS} comparison section 28 determines whether or not the change in movement speed of an occupant ΔV_{SIS} that is input from the ΔV_{SIS} calculation section 26 is greater than a predetermined ΔV_{SIS} threshold value that is input from the ΔV_{SIS} threshold value setting section 27. The result of this determination is output to the collision continuation detecting section 32.

$$Δ {V}_{SIS} = {\int }_{tp - n}^{tp} {G}_{SIS} ( t ) ⅆ t \qquad ( 2 )$$

The ΔV_{hold} calculation section 29 performs a primary integration for time on the acceleration signals G_{SIS} that are output from a side impact sensor (i.e., L-SIS or R-SIS) 12, and, as is shown below in Formula (3), for example, calculates a change in movement speed of an occupant ΔV_{hold} in a time interval having a predetermined time width m relative to the current time tp (i.e., tp−m≦t≦tp), and outputs the result to the ΔV_{hold} comparison section 31.

The ΔV_{hold} comparison section 31 determines whether or not the change in movement speed of an occupant ΔV_{hold} that is input from the ΔV_{hold} calculation section 29 is greater than a predetermined ΔV_{hold} threshold value that is input from the ΔV_{hold} threshold value setting section 30. The result of this determination is output to the collision continuation detecting section 32.

$$Δ {V}_{hold} = {\int }_{tp - m}^{tp} {G}_{hold} ( t ) ⅆ t \qquad ( 3 )$$

The collision continuation detecting section 32 outputs a true value of “1” to the AND circuit 33 as a collision continuation determining value hold, which shows that a state exists in which a collision is continuing, when it is determined by the ΔV_{SIS} comparison section 28 that the change in movement speed of an occupant ΔV_{SIS} that is input from the ΔV_{SIS} calculation section 26 is greater than the predetermined ΔV_{SIS} threshold value that is input from the ΔV_{SIS} threshold value setting section 27, and when it is determined by the ΔV_{hold} comparison section 31 that the change in movement speed of an occupant ΔV_{hold} that is input from the ΔV_{hold} calculation section 29 is greater than the predetermined ΔV_{hold} threshold value that is input from the ΔV_{hold} threshold value setting section 30.

Moreover, when it is determined by the ΔV_{hold} comparison section 31 that the change in movement speed of an occupant ΔV_{hold} that is input from the ΔV_{hold} calculation section 29 is less than the predetermined ΔV_{hold} threshold value that is input from the ΔV_{hold} threshold value setting section 30, a pseudo value of “0” is output as a collision continuation determining value hold to the AND circuit 33.

The AND circuit 33 outputs to the startup signal generating section 34 a signal that is obtained from a logical product of a determination value that is output from the ΔV_{ECU} comparison section 25 and a collision continuation determining value that is output from the collision continuation detecting section 32.

The startup signal generating section 34 outputs, in accordance with a signal that is output from the AND circuit 33, a command signal that causes an occupant protection apparatus such as, for example, an airbag apparatus or a seatbelt pretensioner to be operated.

The collision determining apparatus for a vehicle 10 according to the present embodiment has the above described structure. Next, a description will be given of the operation of this collision determining apparatus for a vehicle 10.

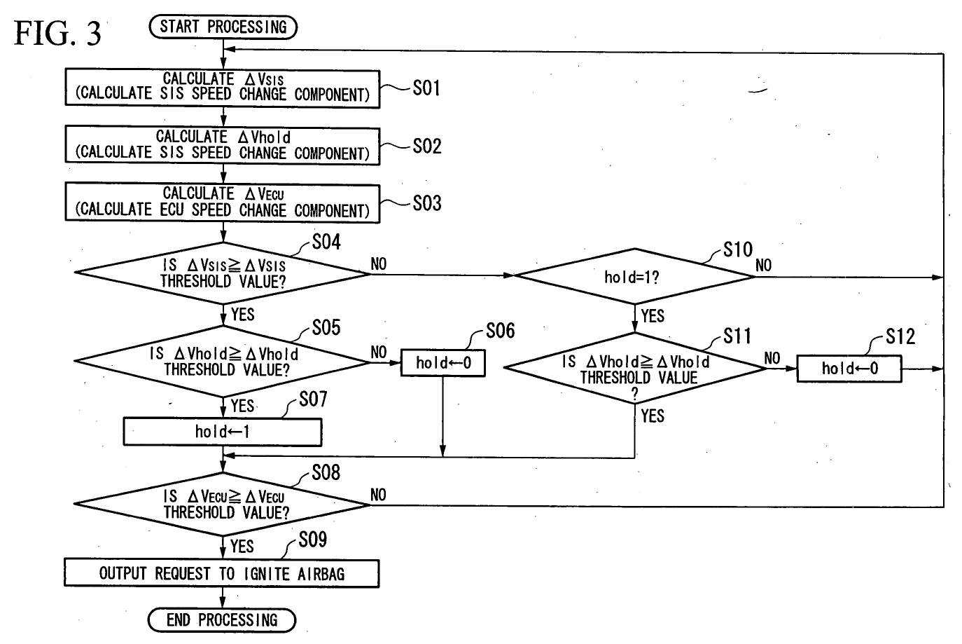

Firstly, in step S01 shown in FIG. 3, primary integration for time is performed on the acceleration signals G_{SIS}, as is shown in Formula (2) above, and a change in movement speed of an occupant ΔV_{SIS} in a time interval having a predetermined time width n relative to the current time tp (i.e., tp−n≦t≦tp) is calculated.

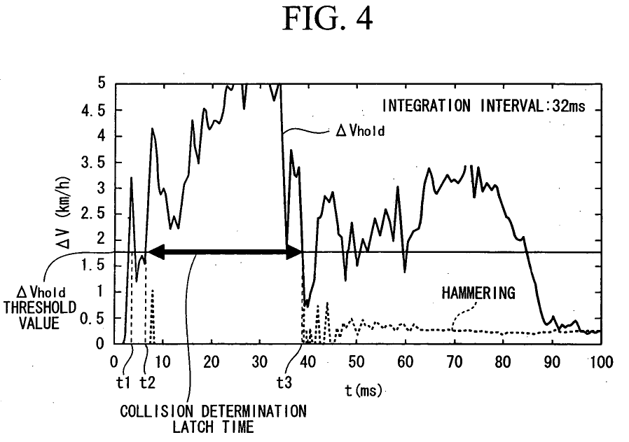

Next, in step S02, primary integration for time is performed on the acceleration signals G_{SIS}, as is shown in Formula (3) above, and a change in movement speed of an occupant ΔV_{hold} in a time interval having a relatively long predetermined time width m (for example, the 32 ms shown in FIG. 4) relative to the current time tp (i.e., tp−m≦t≦tp) is calculated.

Next, in step S03, primary integration for time is performed on the acceleration signals G_{ECU}, as is shown in Formula (1) above, and a change in movement speed of an occupant ΔV_{ECU} in a time interval having a predetermined time width n relative to the current time tp (i.e., tp−n≦t≦tp) is calculated.

Next, in step S04, a determination is made as to whether or not the change in movement speed of an occupant ΔV_{SIS} is equal to or greater than the predetermined ΔV_{SIS} threshold value.

When the result of this determination is “NO”, the routine moves to step S10 (described below).

When, however, the result of this determination is “YES”, the routine moves to step S05.

In step S05, a determination is made as to whether or not the change in movement speed of an occupant ΔV_{hold} is equal to or greater than the predetermined ΔV_{hold} threshold value.

When the result of this determination is “NO”, the routine moves to step S06 and a pseudo value of “0” is set for the collision continuation determining value hold. The routine then moves to step S08.

When, however, the result of this determination is “YES”, the routine moves to step S07 and a true value of “1” is set for the collision continuation determining value hold. The routine then moves to step S08.

In step S08, a determination is made as to whether or not the change in movement speed of an occupant ΔV_{ECU} is equal to or more than the predetermined ΔV_{ECU} threshold value.

When, the result of the determination in step S08 is “NO”, the routine returns to the above described step S01.

When, however, the result of the determination in step S08 is “YES”, a command signal is output requesting an ignition operation in an occupant protection apparatus, for example, an airbag apparatus, and the processing sequence is ended.

In step S10, a determination is made as to whether or not a true value of “1” is set for the collision continuation determining value hold.

When the result of this determination is “NO”, the routine returns to step S01.

When, however, the result of this determination is “YES”, the routine moves to step S11.

In step S11, a determination is made as to whether or not the change in movement speed of an occupant ΔV_{hold} is equal to or more than the predetermined ΔV_{hold} threshold value.

When the result of the determination in step S11 is “NO”, the routine moves to step S12 and a pseudo value of “0” is set for the collision continuation determining value hold. The routine then returns to step S01.

When, however, the result of the determination in step S11 is “YES”, the routine moves to step S08.

As a result of the above, as is shown, for example, in FIG. 4, after the time t1 when the change in movement speed of an occupant ΔV_{SIS} becomes equal to or more than the predetermined ΔV_{SIS} threshold value and the occurrence of a collision is detected, the time period extending from the time t2 to the time t3, during which a state continues in which the change in movement speed of an occupant ΔV_{hold} is equal to or more than the predetermined ΔV_{hold} threshold value, is considered to be a collision continuation state (i.e., a collision determination latch time), and a state in which the change in movement speed of an occupant ΔV_{SIS} is equal to or more than the predetermined ΔV_{SIS} threshold value is also regarded as continuing.

In addition, when the change in movement speed of an occupant ΔV_{ECU} is equal to or more than the predetermined ΔV_{ECU} threshold value in this collision continuation state, a request to ignite an airbag apparatus is output.

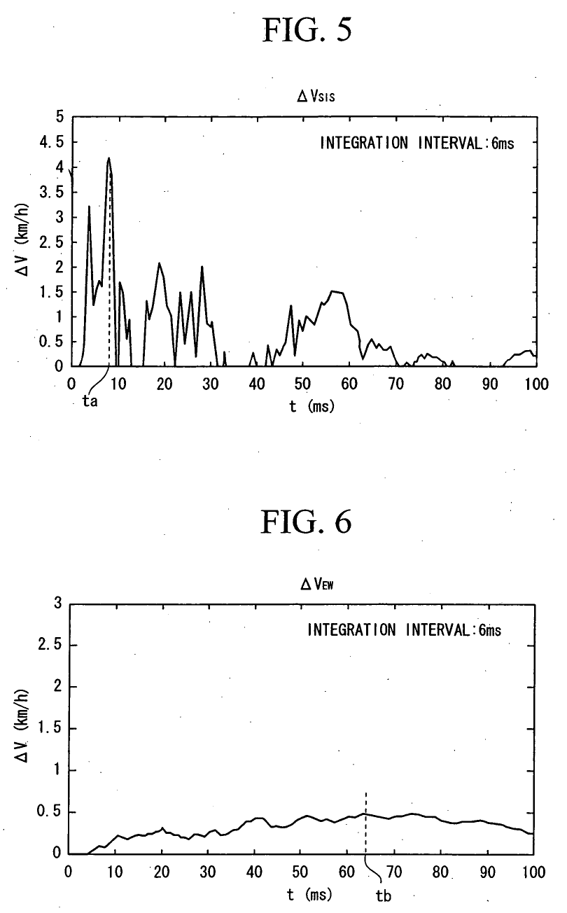

As described above, according to the collision determining apparatus for a vehicle 10 of the present embodiment, in accordance, for example, with the placement positions of the acceleration sensor 21 and the satellite sensors (i.e., the front crash sensors 11 and the side impact sensors 12) as well as the state of the collision that has occurred and the like, as is shown in FIGS. 5 and 6, for example, even if a relatively large discrepancy arises between the timings (for example, the timing ta shown in FIG. 5 and the timing tb shown in FIG. 6) at which integral values (i.e., the change in movement speed of an occupant ΔV_{SIS} and the change in movement speed of an occupant ΔV_{ECU}) of acceleration signals G_{SIS} and G_{ECU} from the acceleration sensor 21 and the satellite sensors are at their maximum, by considering the time period during which a state continues in which the change in movement speed of an occupant ΔV_{hold} is equal to or more than the predetermined ΔV_{hold} threshold value to be a collision continuation state, it is possible, based on the change in movement speed of an occupant ΔV_{SIS} and ΔV_{ECU}, to accurately determine the existence or otherwise of a collision occurrence and to appropriately operate an occupant protection apparatus.

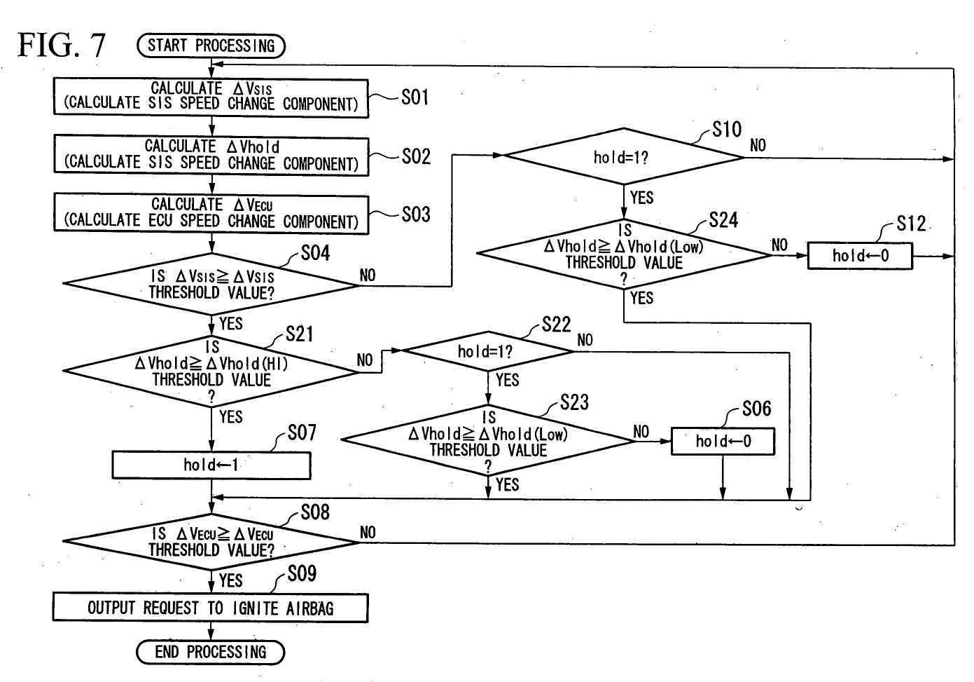

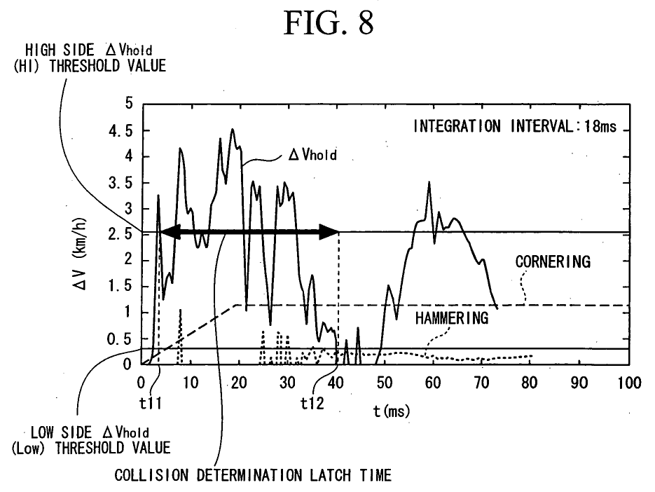

Note that, in the above described embodiment, a determination is made as to whether or not the change in movement speed of an occupant ΔV_{hold} in a time interval (i.e., tp−m≦t≦tp) having a relatively long predetermined time width m relative to the current time tp is equal to or more than the predetermined ΔV_{hold} threshold value, however, the present invention is not limited to this, and, as is shown, for example, in FIG. 7, it is also possible to make a determination as to whether or not the change in movement speed of an occupant ΔV_{hold} in a time interval (i.e., tp−n≦t≦tp) having a shorter predetermined time width n (for example, the 18 ms shown in FIG. 8 or the like) is equal to or less than a predetermined high side ΔV_{hold(HI)} threshold value and is also equal to or more than a predetermined low side ΔV_{hold(Low)} threshold value.

This variant example differs from the above described embodiment in that the processing of step S21 is executed instead of the processing of step S05 shown in FIG. 3, and the processing of step S24 is executed instead of the processing of step S11 shown in FIG. 3.

Namely, in step S21 shown in FIG. 7, a determination is made as to whether or not the change in movement speed of an occupant ΔV_{hold} is equal to or more than the high side ΔV_{hold(HI)} threshold value.

When the result of this determination is “YES”, the routine moves to step S07.

When, however, the result of the determination is “NO”, the routine moves to step S22.

In step S22, a determination is made as to whether or not a true value of “1” is set for the collision continuation determining value hold.

When the result of the determination in step S22 is “NO”, the routine moves to step S08.

When, however, the result of the determination in step S22, is “YES”, the routine moves to step S23.

In step S23, a determination is made as to whether or not the change in movement speed of an occupant ΔV_{hold} is equal to or more than the low side ΔV_{hold(Low)} threshold value.

When the result of the determination in step S23 is “NO”, the routine moves to step S06.

When, however, the result of the determination in step S23 is “YES”, the routine moves to step S08.

In step S24, a determination is made as to whether or not the change in movement speed of an occupant ΔV_{hold} is equal to or more than the low side ΔV_{hold(Low)} threshold value.

When the result of the determination in step S24 is “NO”, the routine moves to step S12.

When, however, the result of the determination in step S24 is “YES”, the routine moves to step S08.

In this variant example, as is shown, for example, in FIG. 8, after the time t11 when the change in movement speed of an occupant ΔV_{SIS} becomes equal to or more than the predetermined ΔV_{SIS} threshold value and the occurrence of a collision is detected, the time period extending from the time t11 when the change in movement speed of an occupant ΔV_{hold} becomes equal to or more than the predetermined high side ΔV_{hold(HI)} threshold value to the time t12 when the change in movement speed of an occupant ΔV_{hold} is less than the low side ΔV_{hold(Low)} threshold value is considered to be a collision continuation state (i.e., a collision determination latch time), and a state in which the change in movement speed of an occupant ΔV_{SIS} is equal to or more than the predetermined ΔV_{SIS} threshold value is also regarded as continuing. In addition, when the change in movement speed of an occupant ΔV_{ECU} is equal to or more than the predetermined ΔV_{ECU} threshold value in this collision continuation state, a request to ignite an airbag apparatus is output.

In this case, the high side ΔV_{hold(HI)} threshold value is set to a value (for example, a value that excludes cornering or the like and acceleration change components that are caused by an acceleration that is generated by a sideways slipping or turning of a vehicle, as is shown in FIG. 8) that allows collisions smaller than a predetermined size to be excluded, and the low side ΔV_{hold(Low)} threshold value is set to a value (for example, the hammering and the like shown in FIG. 8) that allows collisions having a collision energy that will not give rise to any injury to an occupant to be excluded. As a result, the stability and reliability of a collision detection can be improved compared with when the change in movement speed of an occupant ΔV_{hold} is calculated in a time interval (i.e., tp−m≦t≦tp) having a relatively long predetermined time width m.

Note also that, in the above described embodiment, an airbag apparatus and a seatbelt pretensioner are driven and controlled to serve as occupant protection apparatuses, however, the present invention is not limited to this and it is also possible to drive and control seat devices whose seat position and configuration and the like are capable of being altered.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A collision determining apparatus for a vehicle, comprising:
a first acceleration measuring device which measures an acceleration acting on an outer peripheral portion of the vehicle;
a second acceleration measuring device which measures an acceleration acting on a position further to an inner portion side of the vehicle than the first acceleration measuring device;
a first change in movement speed calculating device which calculates a first change in movement speed based on the acceleration which is measured by the first acceleration measuring device;
an interval integral value calculating device which calculates an interval integral value in a relatively long time interval for the acceleration which is measured by the first acceleration measuring device;
a second change in movement speed calculating device which calculates a second change in movement speed based on the acceleration which is measured by the second acceleration measuring device;
a first collision determining device which determines whether or not the first change in movement speed exceeds a predetermined first collision determining threshold value;
a continuation determining device which determines whether or not the interval integral value exceeds a predetermined continuation determining threshold value;
a second collision determining device which determines whether or not the second change in movement speed exceeds a predetermined second collision determining threshold value;
a collision determination continuing device which sets a collision continuation determining value which indicates that a collision is in a state of continuation to an ON state when it is determined by the first collision determining device that the first change in movement speed exceeds the first collision determining threshold value and it is also determined by the continuation determining device that the interval integral value exceeds the continuation determining threshold value, and which sets the collision continuation determining value to an OFF state when it is determined by the continuation determining device that the interval integral value does not exceed the continuation determining threshold value; and
a control signal generating device which generates a control signal which instructs that an occupant protection apparatus be operated when the collision continuation determining value is in an ON state and it is determined by the second collision determining device that the second change in movement speed exceeds the second collision determining threshold value.

2. A collision determining apparatus for a vehicle, comprising:
a first acceleration measuring device that measures an acceleration acting on an outer peripheral portion of the vehicle;
a second acceleration measuring device which measures an acceleration acting on a position further to an inner portion side of the vehicle than the first acceleration measuring device;
a first change in movement speed calculating device which calculates a first change in movement speed based on the acceleration which is measured by the first acceleration measuring device;
an interval integral value calculating device which calculates an interval integral value in a predetermined time interval for the acceleration which is measured by the first acceleration measuring device;
a second change in movement speed calculating device which calculates a second change in movement speed based on the acceleration which is measured by the second acceleration measuring device;
a first collision determining device which determines whether or not the first change in movement speed exceeds a predetermined first collision determining threshold value;
a continuation determining device which determines whether or not the interval integral value exceeds a predetermined high side continuation determining threshold value or a predetermined low side continuation determining threshold value;
a second collision determining device which determines whether or not the second change in movement speed exceeds a predetermined second collision determining threshold value;
a collision determination continuing device which sets a collision continuation determining value which indicates that a collision is in a state of continuation to an ON state when it is determined by the first collision determining device that the first change in movement speed exceeds the first collision determining threshold value and it is also determined by the continuation determining device that the interval integral value exceeds the predetermined high side continuation determining threshold value, and which sets the collision continuation determining value to an OFF state when it is determined by the continuation determining device that the interval integral value is less than the predetermined low side continuation determining threshold value; and
a control signal generating device which generates a control signal which instructs that an occupant protection apparatus be operated when the collision continuation determining value is in an ON state and it is determined by the second collision determining device that the second change in movement speed exceeds the second collision determining threshold value.
